(19) United States
(12) Patent Application Publication
(10) Pub. No.: US 2021/0241589 A1
(43) Pub. Date: Aug. 5, 2021

(54) ALARM SYSTEM CONTAINED IN AN ENCLOSURE

(71) Applicant: DSD TECHNOLOGIE INC., Montreal (CA)

(72) Inventors: Daniel RAMOS, Saint-Paul-de-l'Ile-aux-Noix (CA); David ST-JEAN, Saint-Sebastien (CA)

(21) Appl. No.: 16/890,276

(22) Filed: Jun. 2, 2020

Related U.S. Application Data
(60) Provisional application No. 62/856,839, filed on Jun. 4, 2019.

(51) Int. Cl. G08B 13/12; G08B 3/10; G08B 25/10

(52) U.S. Cl. CPC G08B 13/12; G08B 25/10; G08B 3/10

(57) ABSTRACT

An alarm system comprises an enclosure, a power source, an alerting module, a sensor and a controller. The power source, the alerting module, the sensor and the controller are contained in the enclosure. The alerting module generates an alarm when receiving power from the power source. The sensor detects its own position information. A sensitivity of the sensor is sufficient to detect an opening of the enclosure. The controller is operatively connected to the power source, the alerting module and the sensor. The controller receives the position information from the sensor, detects a change of the position information received from the sensor and, in response to detecting the change of the position information, causes the power source to deliver power to the alerting module.

### CROSS-REFERENCE

The present application claims priority from U.S. Provisional Patent Application Ser. No. 62/856,839, filed on Jun. 4, 2019, the disclosure of which is incorporated by reference herein.

### TECHNICAL FIELD

The present disclosure relates to the field of security devices. More specifically, the present disclosure relates to an alarm system contained in an enclosure.

### BACKGROUND

Conventional alarm systems installed in cars, boats, trailers, and like vehicles, are vulnerable and easy to defeat. They usually comprise at least one vulnerable component, for example a sensor, a power supply, or even a simple wire, which can be bypassed or inactivated.

Some alarm systems include a time delay so that the actual alarm is triggered several seconds after entry into the vehicle, allowing some time for the legitimate user to access a panel to disable the system.

Experienced criminals have developed techniques to use these delays and other vulnerabilities to disable most alarm systems.

Therefore, there is a need for improvements in alarm systems that compensate for problems related to known vulnerabilities.

### SUMMARY

According to the present disclosure, there is provided an alarm system comprises an enclosure, a power source, an alerting module, a sensor and a controller. The power source, the alerting module, the sensor and the controller are contained in the enclosure. The alerting module is adapted to generate an alarm when receiving power from the power source. The sensor is adapted to detect a position information of the sensor. A sensitivity of the sensor is sufficient to detect an opening of the enclosure. The controller is operatively connected to the power source, the alerting module and the sensor. The controller is configured to receive the position information from the sensor, detect a change of the position information received from the sensor and, in response to detecting the change of the position information, cause the power source to deliver power to the alerting module.

In some implementations of the present technology, the alerting module comprises a sound output device and the generated alarm is an audible sound.

In some implementations of the present technology, the sound output device is a siren.

In some implementations of the present technology, the alerting module comprises a wireless transmitter adapted to transmit an alert signal toward a remote alerting module.

In some implementations of the present technology, the alarm system further comprises a relay contained in the enclosure, the controller being further configured to cause the relay to connect the alerting module to the power source in response to detecting the change of the position information.

In some implementations of the present technology, the controller is further configured to cause the relay to disconnect the alerting module from the power source a predetermined period of time after the connection of the alerting module to the power source.

In some implementations of the present technology, the alarm system further comprises a power converter contained in the enclosure, electrically connected to the power source and adapted to energize the sensor and the controller.

In some implementations of the present technology, the alarm system further comprises a wireless receiver contained in the enclosure, energized by the power converter and adapted to: receive, from a remote terminal, commands to turn on and turn off the alarm system; electrically connect the sensor, the relay and the controller to the power converter when receiving the command to turn on the alarm system; and disconnect the sensor, the relay and the controller from the power converter when receiving the command to turn off the alarm system.

In some implementations of the present technology, the power source is a battery of a vehicle.

In some implementations of the present technology, the sensor is a gyroscope.

In some implementations of the present technology, the sensor is further adapted to calculate the position information of the alarm system at regular intervals; and the controller is further adapted to: receive the position information at each regular interval, and cause the power source to deliver power to the alerting module when a difference between a newly received position information and position information stored in the controller is greater than a predetermined threshold.

In some implementations of the present technology, the sensor is further adapted to calculate the position information of the alarm system as a three-dimensional (3D) data set; and the controller is further adapted to: compare a newly received 3D data set with a stored 3D data set, and cause the power source to deliver power to the alerting module when a difference between at least one dimension of the newly received 3D data set and a corresponding at least one dimension of the stored 3D data set is greater than the predetermined threshold.

In some implementations of the present technology, the enclosure is a lockable enclosure.

The foregoing and other features will become more apparent upon reading of the following non-restrictive description of illustrative embodiments thereof, given by way of example only with reference to the accompanying drawings.

### BRIEF DESCRIPTION OF THE DRAWINGS

Embodiments of the disclosure will be described by way of example only with reference to the accompanying drawings, in which:

FIG. 1 is a schematic block diagram of an alarm system according to an embodiment;

FIG. 2 is a top perspective view of a power converter of the alarm system of FIG. 1;

FIG. 3a is a top perspective view of a wireless receiver of the alarm system of FIG. 1;

FIG. 3b is a bottom perspective view of the wireless receiver of FIG. 3a;

FIG. 4 is a top plan view of a remote terminal for sending commands to the wireless receiver of FIGS. 3a and 3b;

FIG. 5 is a top plan view of a gyroscope of the alarm system of FIG. 1;

FIG. 6 is a top plan view of a controller of the alarm system of FIG. 1;

FIG. 7 is a perspective view of a relay of the alarm system of FIG. 1;

FIG. 8 is a top plan view of a siren of the alarm system of FIG. 1;

FIG. 9a is a perspective view of a battery box for receiving the alarm system of FIG. 1;

FIG. 9b is a perspective view of the battery box of FIG. 9a showing a battery and an internal box receiving the alarm system of FIG. 1; and

FIG. 10 is a sequence diagram showing operations of the alarm system according to an embodiment.

Like numerals represent like features on the various drawings. The various drawings are not to scale.

### DETAILED DESCRIPTION

Various aspects of the present disclosure generally address one or more of the problems related to known vulnerabilities of conventional alarm systems.

Generally speaking, an alarm system constructed according to the present technology includes a sensor, a controller capable of detecting a motion of the alarm system based on readings from the sensor, a relay that may be activated by the controller for delivery of power from a power source to a sound output device. The sensor, the controller, the relay, the sound output device and the power source are all contained in an enclosure. The sensor has a sufficient sensitivity to detect an opening of the enclosure. The alarm system can be installed on a boat, on a trailer, on a car, on a motorcycle, on an all-terrain vehicle (ATV), and the like. The sensor can detect a movement of the vehicle. None of the components of the alarm system is exposed outside of the enclosure. Any attempt to defeat the alarm system or one of its components would first require opening of the enclosure, which would trigger the alarm system and emission of a loud alarm signal from the sound output device.

The present disclosure describes embodiments of the alarm system in the context of its use in a vehicle. However, the present technology is not limited to vehicular applications. Variants of the alarm system as shown and described may be used in other contexts where theft deterrence is desired.

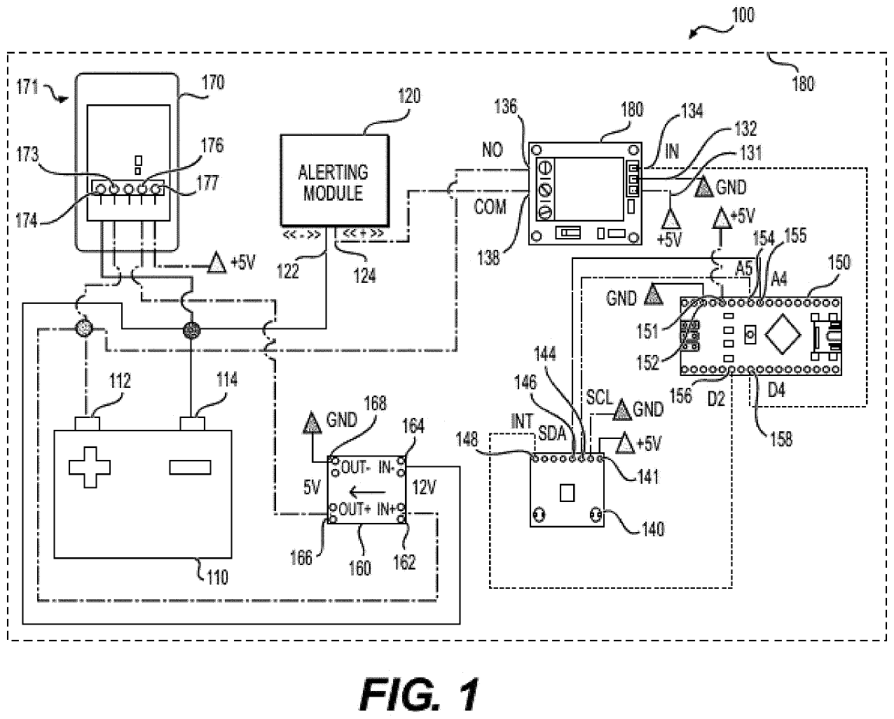

Referring now to the drawings, FIG. 1 is a schematic block diagram of an alarm system according to an embodiment. An alarm system 100 comprises a power source, for example a battery 110, for example a conventional 12-volt battery as present in most cars, boats, trucks, motorcycles, ATVs, and like vehicles. The alarm system 100 also comprises an alerting module 120, a relay 130, a sensor capable of sensing its own position (and thereby a position of the alarm system 100), for example a gyroscope 140 capable of sensing its own position as a three-dimensional (3D) data set, and a controller 150. The alarm system 100 may also comprise a power converter 160, for example a DC-DC power converter adapted to convert a 12-volt output from the battery 110 to a 5-volt output that is convenient to provide power to electronic components of the alarm system 100, as well as a wireless receiver 170. All of these components of the alarm system 100 are contained in an enclosure, which may be a lockable enclosure, for example and without limitation a battery box 180 such as those used in marine applications. Electrical connections between the various components of the alarm system 100 may be via wires (not shown) that are schematically identified by lines shown between each component of FIG. 1.

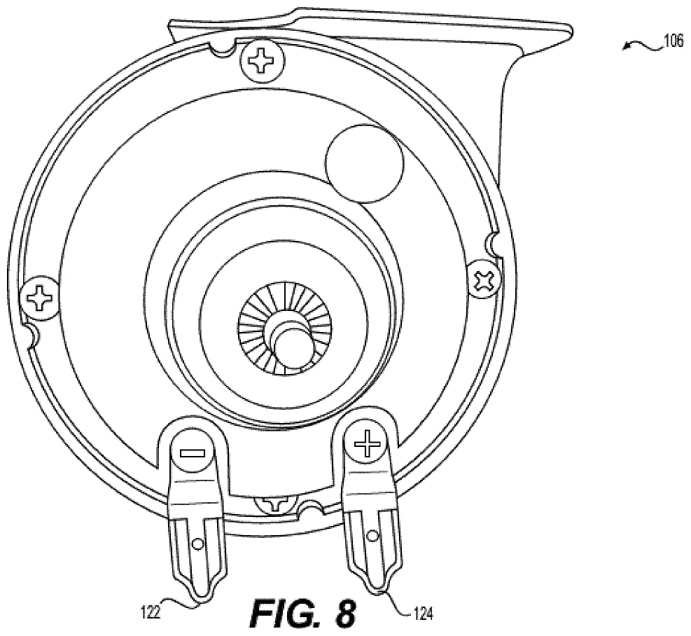

The battery 110 has a positive terminal 112 and a negative terminal 114. The alerting module 120 has a negative terminal 122, which is directly connected to the negative terminal 114 of the battery 110, and a positive terminal 124, which may receive power from the relay 130 when the relay 130 is closed. The alerting module 120 may comprise a sound output device, for example a siren 126 (FIG. 8) or a horn, the sound output device generating an audible sound when energized via the relay 130. Alternatively, the alerting module 120 may comprise a wireless transmitter (not shown) adapted to transmit an alert signal toward a remote alerting module (not shown) when energized via the relay 130.

In an embodiment, the relay 130, the gyroscope 140, the controller 150, the power converter 160, the wireless receiver 170 and the alerting module 120 may be fixedly mounted on an internal face (not shown) of the battery box 180, attached to the battery 110, or mounted on a board (not shown) inserted in the battery box 180, in order to maintain a fixed relative position between these components of the alarm system 100. Although optional, this configuration allows specifying a finer sensitivity of a detection by the alarm system 100.

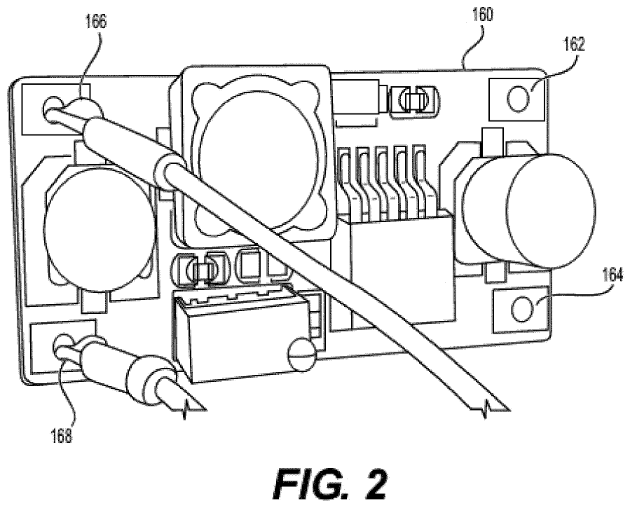

FIG. 2 is a top perspective view of a power converter of the alarm system of FIG. 1. The power converter 160 includes positive and negative inputs 162, 164 that are respectively connected to the positive and negative terminals 112, 114 of the battery 110 for receiving 12-volt power. The power converter 160 also includes positive and negative outputs 166, 168 for outputting 5-volt power. The negative output 168 is connected to a common ground (GND) for the alarm system 100. The negative terminal 114 of the battery 110 may also be connected to the common ground.

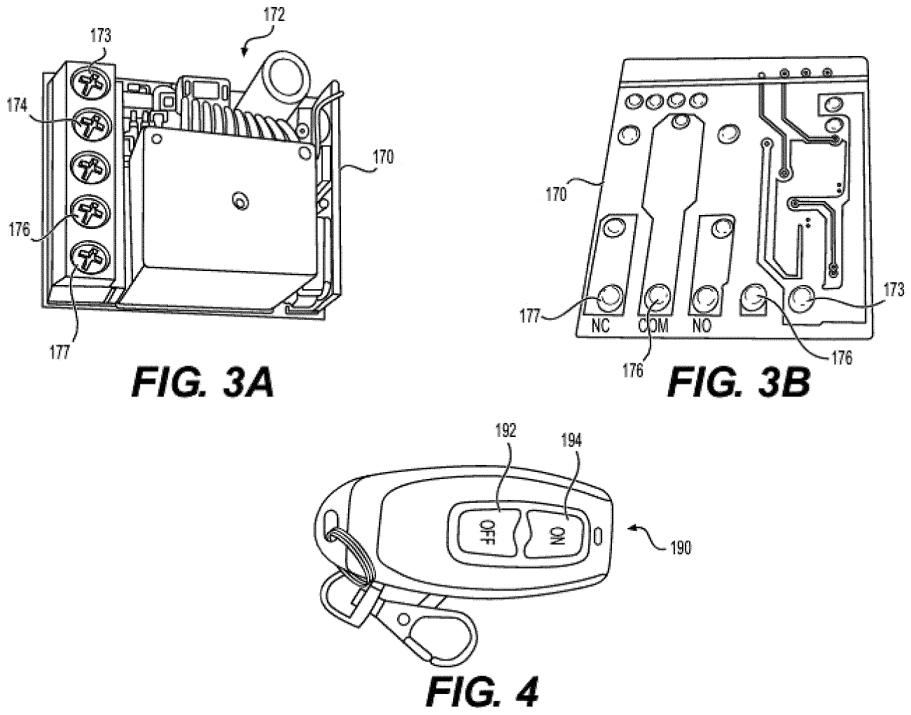

FIG. 3a is a top perspective view of a wireless receiver of the alarm system of FIG. 1. FIG. 3b is a bottom perspective view of the wireless receiver of FIG. 3a. Referring to FIGS. 3a and 3b, the wireless receiver 170 is shown without an external cover 171 visible on FIG. 1. The wireless receiver 170 may for example and without limitation be a KTNN-KG1201-A single channel 433 MHz relay module from KTNNKG™. The wireless receiver 170 includes a 12-volt circuitry 172 receiving power from positive and negative inputs 173, 174 that are respectively connected to the positive and negative terminals 112, 114 of the battery 110 for receiving 12-volt power. The wireless receiver 170 also includes a common input 176 (marked COM in the drawings), which is connected to the 5-volt positive output 166 of the power converter 160. A switched output 177 (marked NC in the drawings) is wirelessly controlled for selectably outputting 5-volt power from the common input 176. Another terminal (marked NO in the drawings) of the wireless receiver 170 is not used in the alarm system 100.

FIG. 4 is a top plan view of a remote terminal for sending commands to the wireless receiver of FIGS. 3a and 3b. In the same non-limiting embodiment, a remote terminal 190 is also from KTNNKG™, operates at 433 MHz, and is adapted for operating with the wireless receiver 170. The remote terminal 20 and the wireless receiver 170 share a secret code to prevent unauthorized disarming of the alarm system 100. The remote terminal 190 includes button 192 and 194 for respectively turning off and on the alarm system 100 by opening or closing a connection between the common input 176 and the switched output 177 of the wireless receiver 170. The remote terminal 190 includes an internal battery (not shown).

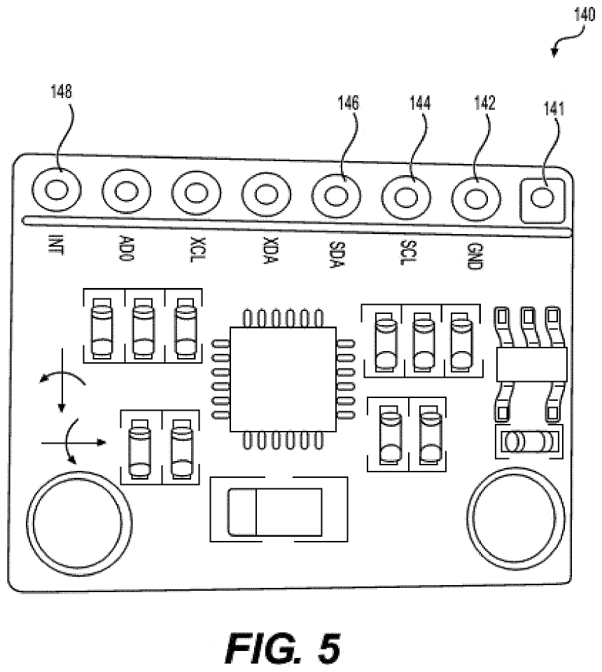

FIG. 5 is a top plan view of a gyroscope of the alarm system of FIG. 1. The gyroscope 140 may, for example and without limitation, be a MPU-6050 device from InvenSense™. The gyroscope 140 includes a 5-volt terminal 141 that is connected to the switched output 177 of the wireless receiver 170 to receive therefrom 5-volt power when the alarm system 100 is activated. A terminal 142 is connected to the common ground (GND). On the gyroscope 140, a serial clock (SCL) input 144 receives a clock signal from the controller 150 and a signals serial data (SDA) input/output 146 forwards 3D position information to the controller. An interrupt (INT) output 148 provides interrupts to the controller 150 when new data is available on the SDA input/output 146.

Other connections marked XDA, XCL and AD0 on FIG. 5 are not used in the alarm system 100. More details of the gyroscope 140 may be found in MPU-6000 and MPU-6050 Product Specification Revision 3.4, from InvenSense™, Document Number PS-MPU-6000A-00 Revision 3.4, Aug. 19, 2013, the disclosure of which is incorporated by reference herein.

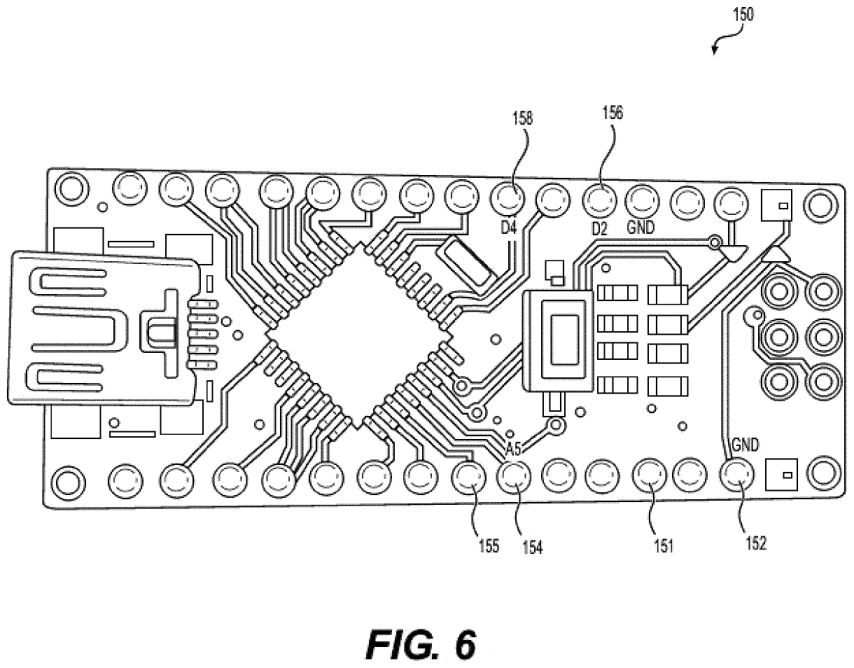

FIG. 6 is a top plan view of a controller of the alarm system of FIG. 1. The controller 150 may, for example and without limitation, be a Nano device from Arduino™. The controller 150 includes a 5-volt terminal 151 that is connected to the switched output 177 of the wireless receiver 170 to receive therefrom 5-volt power when the alarm system 100 is activated. A terminal 152 is connected to the common ground (GND). A clock (A5) terminal 154 provides the clock signal to the SCL input 144 of the gyroscope 140. Although the gyroscope 140 and the controller 150 are capable of operating at much faster rates, in an embodiment, the controller 150 is programmed so that the clock signal causes the gyroscope 140 to provide updated 3D position information several times per second, for example 10 times per second. A data terminal 155 (A5) receives the 3D position information from the SDA input/output 146 of the gyroscope 140. Optionally, the controller 150 may provide configuration information to the gyroscope 140 via the data terminal 155, for example for adjusting the sensitivity of the gyroscope 140. An data input 156 (D2) receives interrupts from the interrupt output 148 of the gyroscope 140 when new 3D position information is available at the data terminal 155. When the controller 150 determines that a difference between previously received 3D position information and newly received 3D position information exceeds a predetermined threshold, the controller 150 outputs an enabling signal on a data output 158 (D4), the enabling signal being applied on the relay 130.

The controller 150 of FIG. 6 as illustrated includes a plurality of other connections that are not used in the alarm system 100.

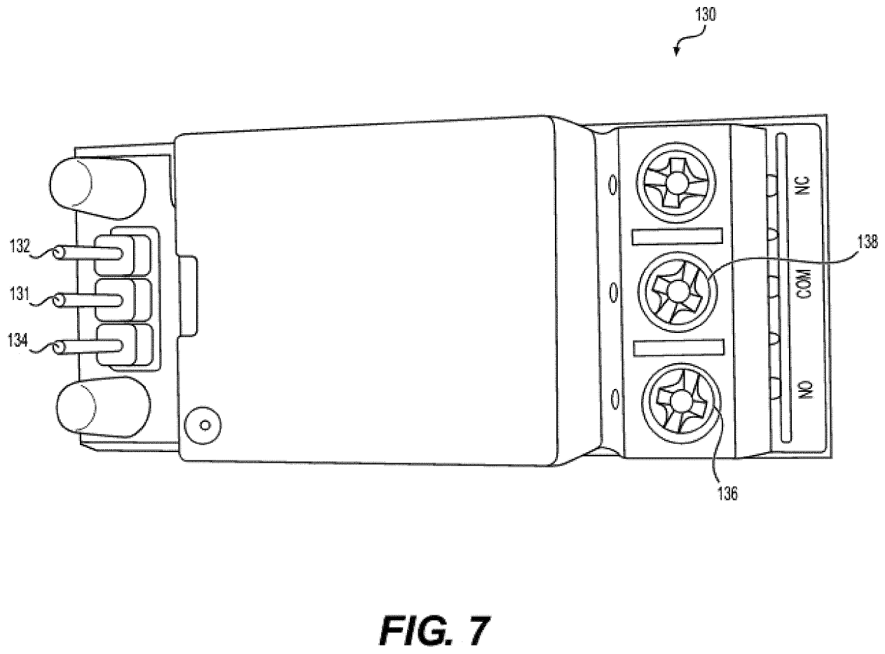

FIG. 7 is a perspective view of a relay of the alarm system of FIG. 1. The relay 170 may, for example and without limitation, be a RM 3.00 one channel relay module from Tongling Jinsai Electronics™. The relay 130 includes a 5-volt terminal 131 that is connected to the switched output 177 of the wireless receiver 170 to receive therefrom 5-volt power when the alarm system 100 is activated. A terminal 132 is connected to the common ground (GND). The enabling signal from the controller 150 is applied on a trigger terminal 134 of the relay 130. A power input terminal 136 (NO) is connected to the positive terminal 112 of the battery 110 to receive 12-volt power from the battery 110. An internal connection of the power input terminal 134 and of a switched terminal 138 (COM) is made when the enabling signal is applied by the controller 150 to the trigger terminal 134.

The relay 170 as shown further comprise a NC connector as well as red and green light emitting diodes (LED) that are not used in the alarm system 100.

FIG. 8 is a top plan view of a siren of the alarm system of FIG. 1. In an embodiment, the alerting module 120 is a siren 126 or any other type of sound output device that operates with a 12-volt power input and that emits a characteristic alarm sound, with a loudness that is sufficient for the task at hand. The siren 126 has a negative terminal 122 connected to the negative terminal 114 of the battery 110, and a positive terminal 124 connected to the switched terminal 138 of the relay 130 to receive 12-volt power therefrom. The shown siren 126 has a relatively flat configuration in order to limit a space required for mounting the siren 126 in the battery box 180.

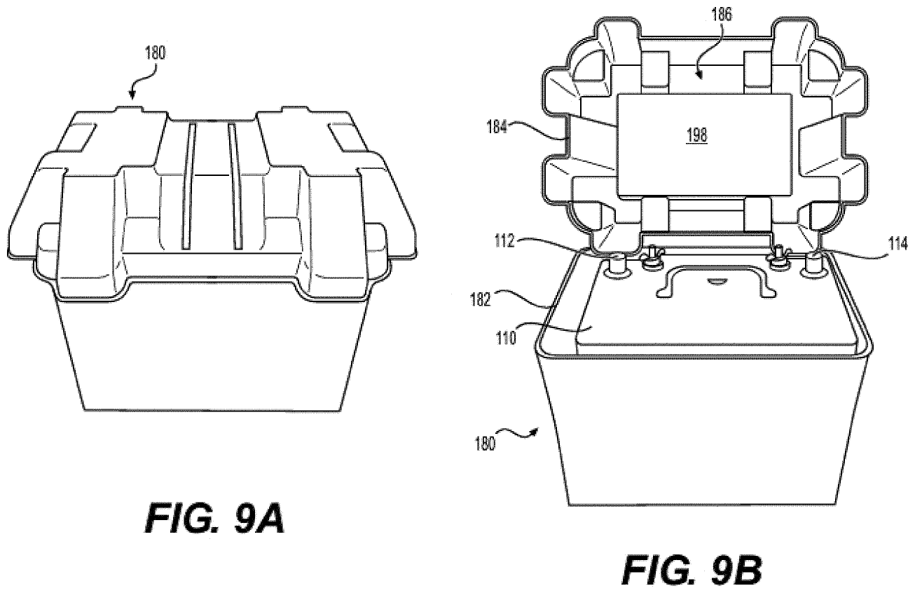

FIG. 9a is a perspective view of a battery box for receiving the alarm system of FIG. 1. FIG. 9b is a perspective view of the battery box of FIG. 9a showing a battery and an internal box receiving the alarm system of FIG. 1. Referring to FIGS. 9a and 9b, the battery box 180 as illustrated is one of many possible configurations of the enclosure for receiving the various components of the alarm system 100. The battery box 180 may be lockable using a padlock (not shown) or using an integral lock (not shown). The illustrated battery box 180 comprises a main container 182 and a top lid 184. Hinges (not shown) may connect the top lid 184 to an edge of the main container 182.

Optionally, mounting at least the gyroscope 140 of the alarm system 100 on an internal face 186 of the top lid 184 ensures that lifting of the top lid 184 will cause a change of position of the gyroscope 140 that will be detected by the controller 150. In the embodiment as shown on FIG. 9b, all components of the alarm system 100, other than the battery 110, are located within an internal box 198 that is held between projections 188 the internal face 186 of the top lid 184, wires (not shown) connecting the alarm system 100 to the battery 110. Adding another battery (not shown) within the internal box 198 to render the alarm system 100 self-contained with the internal box 198 is also contemplated.

Although not shown on FIG. 9, the battery box 180 may comprise external terminals that are internally connected to the positive and negative terminals 112, 114 of the battery 110 for providing 12-volt power to a boat or other vehicle with the top lid 184 in a closed position. Some applications such as boats and other vehicles may be equipped with permanently installed battery boxes. In these applications, the alarm system 100, including the battery 110 and the other components, may be mounted in the permanently installed battery box.

Returning now to FIG. 1, in the illustrated embodiment, the power converter 160 and the wireless receiver 170 receive 12-volt power from the battery 110. The power converter 160 provides 5-volt power to the common input 176 of the wireless receiver 170. When a last command received by the wireless receiver 170 is a command to turn off the alarm system 100, the switched output 177 is disconnected from the common input 176 and the relay 130, the gyroscope 140 and the controller 150 are not energized.

The wireless receiver 170 connects the switched output 177 to the common input 176 when it receives a command to turn on the alarm system 100, resulting in the application of the 5-volt power to energize the relay 130, the gyroscope 140 and the controller 150. The controller 150 starts sending the clock signal to the gyroscope at regular intervals. At each interval, the gyroscope 140 sends its own position information, for example 3D position information, to the controller 150. The controller 150 compares the received position information with previously received position information to detect a change of the position information.

In an embodiment, the controller 150 may compare the present position information with a last received position information. In another embodiment, the controller 150 may evaluate a trend of change of the position information. In these or other embodiments, the controller 150 may react to a change of at least one of three (3) dimensions of the position information. In these or in still further embodiments, the controller 150 may react to a change of position information that exceeds a predetermined threshold so that minor vibrations, for example resulting from wind or other vehicles passing near a vehicle equipped with the alarm system 100, will not trigger an alarm.

Provided that the controller 150 detects a change of position information, it applies the enabling signal to the relay 130. In turn, the relay 130 establishes a connection of the positive terminal 124 of the alerting module 120 with the positive terminal 112 of the battery 110, resulting in the generation of an alarm by the alerting module 120. If the alerting module 120 comprises the siren 126, the siren 126 starts emitting a loud sound. If the alerting module 120 comprises a wireless transmitter, the wireless transmitter starts emitting an alert signal that should be received at a remote alerting module that, in turn, may provide an visual and/or audible alarm indication.

The controller 150 may initiate a timer when it first applies the enabling signal to the relay 130. The enabling signal may be maintained by the controller 150 for a programmable, predetermined period of time, for example five (5) minutes, following which it stops applying the enabling signal to the relay 130 in order to stop the alarm.

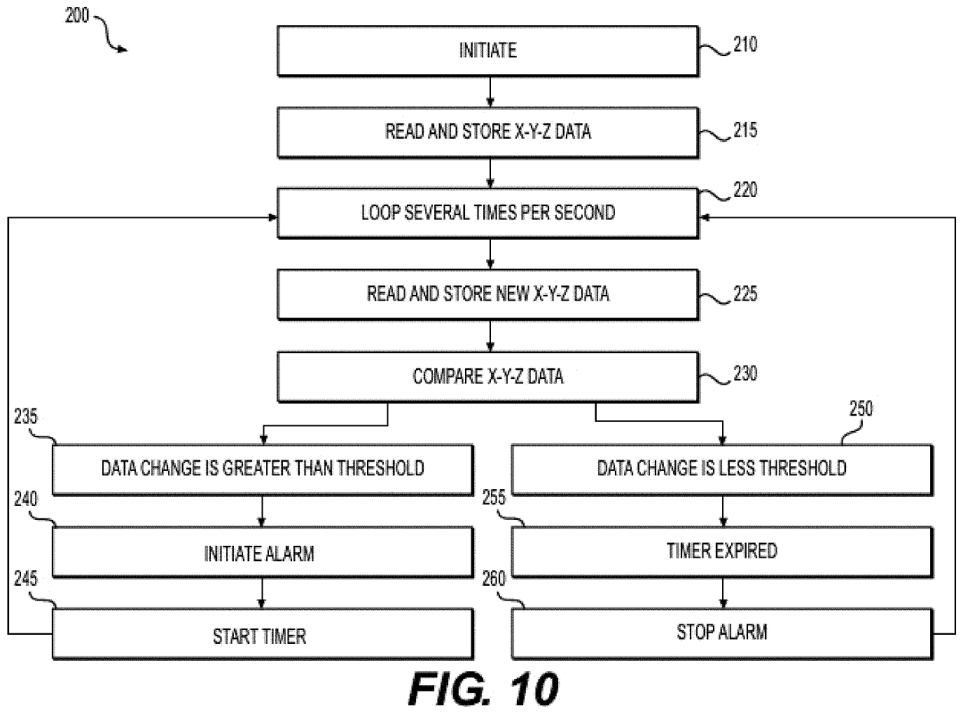

FIG. 10 is a sequence diagram showing operations of the alarm system according to an embodiment. On FIG. 9, a sequence 200 comprises a plurality of operations, some of which may be executed in variable order, some of the operations possibly being executed concurrently, some of the operations being optional. The sequence is initiated as operation 210 when the wireless terminal 170 receives a command to turn on the alarm system 100. The gyroscope 140 outputs 3D position information (for example along x-y-z Cartesian coordinates) and forwards the 3D position information to the controller 150 for storage at operation 215. A continuous loop is initiated at operation 220, following operations within the loop being executed several times per second, for example 10 times per second. The gyroscope 140 outputs 3D position information and forwards the 3D position information to the controller 150 for storage at operation 225. At operation 230, the controller 150 compares the 3D position information received at operation 225 with previously received 3D position information. The 3D position information may have been previously received in a previous instance of the or, it this is a first instance of the loop, at operation 215.

If the controller 150 determines at operation 235 that the data indicative of the 3D position has changed by more than a predetermined threshold, an alarm needs to be triggered. The controller 150 initiates the alarm by sending the enabling signal to the relay 130 at operation 240. The controller also starts a timer for eventually stopping the alarm at operation 245, the timer having a predetermined duration, for example a 5-minute duration. The sequence 200 continues at operation 220 for another instance of the loop. If the 3D position keeps on changing in a next instance of the loop, the timer is initiated again at the next pass of operation 245. In this manner, the alarm duration is effectively determined according to a time when an intrusion attempt is stopped.

If the controller 150 determines at operation 250 that the data indicative of the 3D position has not changed by more than the predetermined threshold, no new alarm needs to be triggered. However, an alarm may have been previously triggered. The controller 150 verifies at operation 255 whether the timer has expired. The timer may be expired either because there is no current alarm or because a current alarm has just reached the end of its predetermined duration. In either case, the controller 150 maintains the enabling signal sent to the relay 130 if the timer is not expired, or otherwise removes the enabling signal to stop the alarm at operation 260. In any case, the sequence 200 continues at operation 220 for another instance of the loop.

Receiving a command to turn off the alarm system 100 at the wireless receiver 170 results in the removal of the 5-volt power on the relay 130, the gyroscope 140 and the controller 150. The sequence 200 is immediately stopped. The internal connection between the power input terminal 134 and the switched terminal 138 of the relay 130 is released and the 12-volt power is no longer applied to the alerting module 120, which terminates the alarm.

Those of ordinary skill in the art will realize that the description of the alarm system are illustrative only and are not intended to be in any way limiting. Other embodiments will readily suggest themselves to such persons with ordinary skill in the art having the benefit of the present disclosure. Furthermore, the disclosed alarm system may be customized to offer valuable solutions to existing needs and problems vulnerabilities of conventional alarm systems. In the interest of clarity, not all of the routine features of the implementations of the alarm system are shown and described. In particular, combinations of features are not limited to those presented in the foregoing description as combinations of elements listed in the appended claims form an integral part of the present disclosure. It will, of course, be appreciated that in the development of any such actual implementation of the alarm system, numerous implementation-specific decisions may need to be made in order to achieve the developer's specific goals, such as compliance with application-related, system-related, and business-related constraints, and that these specific goals will vary from one implementation to another and from one developer to another. Moreover, it will be appreciated that a development effort might be complex and time-consuming, but would nevertheless be a routine undertaking of engineering for those of ordinary skill in the field of security devices having the benefit of the present disclosure.

The present disclosure has been described in the foregoing specification by means of non-restrictive illustrative embodiments provided as examples. These illustrative embodiments may be modified at will. The scope of the claims should not be limited by the embodiments set forth in the examples, but should be given the broadest interpretation consistent with the description as a whole.

What is claimed is:

1. An alarm system, comprising:
an enclosure;
a power source contained in the enclosure;
an alerting module contained in the enclosure and adapted to generate an alarm when receiving power from the power source;
a sensor contained in the enclosure and adapted to detect a position information of the sensor, a sensitivity of the sensor being sufficient to detect an opening of the enclosure; and
a controller contained in the enclosure and operatively connected to the power source, the alerting module and the sensor, the controller being configured to:
receive the position information from the sensor,
detect a change of the position information received from the sensor, and
in response to detecting the change of the position information, cause the power source to deliver power to the alerting module.

2. The alarm system of claim 1, wherein the alerting module comprises a sound output device and the generated alarm is an audible sound.

3. The alarm system of claim 2, wherein the sound output device is a siren.

4. The alarm system of claim 1, wherein the alerting module comprises a wireless transmitter adapted to transmit an alert signal toward a remote alerting module.

5. The alarm system of claim 1, further comprising a relay contained in the enclosure, the controller being further configured to cause the relay to connect the alerting module to the power source in response to detecting the change of the position information.

6. The alarm system of claim 5, wherein the controller is further configured to cause the relay to disconnect the alerting module from the power source a predetermined period of time after the connection of the alerting module to the power source.

7. The alarm system of claim 1, further comprising a power converter contained in the enclosure, electrically connected to the power source and adapted to energize the sensor and the controller.

8. The alarm system of claim 7, further comprising a wireless receiver contained in the enclosure, energized by the power converter and adapted to:
receive, from a remote terminal, commands to turn on and turn off the alarm system;
electrically connect the sensor and the controller to the power converter when receiving the command to turn on the alarm system; and
disconnect the sensor and the controller from the power converter when receiving the command to turn off the alarm system.

9. The alarm system of claim 1, wherein the power source is a battery of a vehicle.

10. The alarm system of claim 1, wherein the sensor is a gyroscope.

11. The alarm system of claim 1, wherein :
the sensor is further adapted to calculate the position information of the alarm system at regular intervals; and
the controller is further adapted to:
receive the position information at each regular interval, and
cause the power source to deliver power to the alerting module when a difference between a newly received position information and position information stored in the controller is greater than a predetermined threshold.

12. The alarm system of claim 11, wherein:
the sensor is further adapted to calculate the position information of the alarm system as a three-dimensional (3D) data set; and
the controller is further adapted to:
compare a newly received 3D data set with a stored 3D data set, and
cause to the power source to deliver power to the alerting module when a difference between at least one dimension of the newly received 3D data set and a corresponding at least one dimension of the stored 3D data set is greater than the predetermined threshold.

13. The alarm system of claim 1, wherein the enclosure is a lockable enclosure.
